(19) United States
(12) Patent Application Publication
(10) Pub. No.: US 2021/0090545 A1
(43) Pub. Date: Mar. 25, 2021

(54) AUDIO SETTING MODIFICATION BASED ON PRESENCE DETECTION

(71) Applicant: HEWLETT-PACKARD DEVELOPMENT COMPANY, L.P., Spring, TX (US)

(72) Inventors: Alexander Wayne Clark, Spring, TX (US); Henry Wang, Fort Collins, CO (US)

(73) Assignee: HEWLETT-PACKARD DEVELOPMENT COMPANY, L.P., Spring, TX (US)

(21) Appl. No.: 16/603,364

(22) PCT Filed: Apr. 12, 2017
(86) PCT No.: PCT/US2017/027234

§ 371 Date: Oct. 7, 2019

(51) Int. Cl. G10K 11/178; G06K 9/00; H04N 5/33; G06F 3/16

(52) U.S. Cl. CPC G10K 11/17837; G06K 9/00362; G06K 9/00228; G06K 9/00288; G10K 2210/3011; G06F 3/165; G10K 11/17885; G10K 2210/108; H04N 5/33

(57) ABSTRACT

In some examples, an audio output device can provide audio setting modification based on presence detection by receiving an input from a camera in response to the camera detecting the presence of a person, and modify an audio setting of the audio output device in response to receiving the input from the camera.

### BACKGROUND

Audio output devices may utilize techniques for reducing ambient sounds. For example, some audio output device may utilize noise-cancellation techniques so that ambient sounds are reduced relative to an audio output of the audio output device. Audio output devices may allow a user of an audio output device to hear the audio output of the audio output device rather than ambient sounds around the user of the audio output device.

### BRIEF DESCRIPTION OF THE DRAWINGS

FIG. 1 illustrates an example of a system suitable for audio setting modification based on presence detection consistent with the disclosure.

FIG. 2 illustrates a block diagram of an example of an audio output device consistent with the disclosure.

FIG. 3 illustrates a block diagram of an example of a system suitable for audio setting modification based on presence detection consistent with the disclosure.

FIG. 4 illustrates an example of a method for audio setting modification based on presence detection consistent with the disclosure.

### DETAILED DESCRIPTION

Audio output devices utilizing techniques such as noise-cancellation to reduce ambient sounds can allow a user to focus on an audio output of the audio output device. For example, noise-cancellation can reduce and/or eliminate ambient sounds around the user so that the user may not be distracted from the audio output of the audio output device.

In some instances, a user of an audio output device may not realize another person requests their attention. For example, the user of the audio output device may be utilizing noise-cancellation while on a telephone call so that the user is focused on the telephone call rather than ambient sounds from the environment around the user. However, the user may be unaware of another person requesting the attention of the user as a result of the noise-cancellation of the audio output device. The other person may have to physically touch the user of the audio output device to gain the user's attention. The user of the audio output device may have to remove the audio output device to hear the other person or other sounds from the ambient environment around the user, distracting them from the telephone call or other audio output of the audio output device.

Audio setting modification based on presence detection can allow for modification of audio settings of an audio output device. Modification of audio settings of an audio output device based on presence detection can allow a user to more easily determine whether their attention is requested while maintaining focus on the audio output of the audio output device. A user of the audio output device may be motivated to utilize the audio output device while being aware of the ambient environment around the user. As a result, a user can remain productive while reducing distractions.

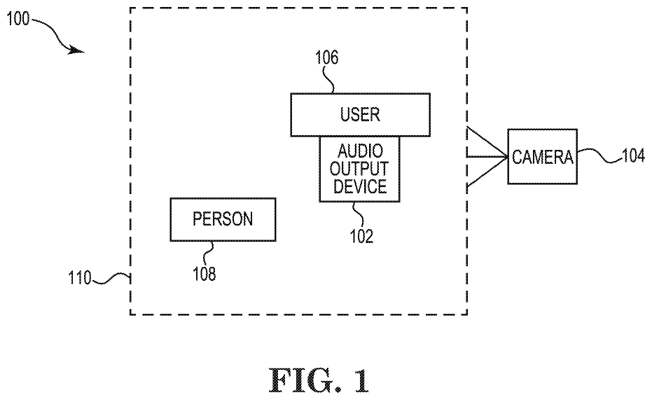

FIG. 1 illustrates an example of a system 100 suitable for audio setting modification based on presence detection consistent with the disclosure. System 100 can include an audio output device 102, a camera 104, a user 106, a person 108, and a threshold distance 110.

System 100 can include audio output device 102. As used herein, the term “audio output device” can, for example, refer to a device capable of converting electrical signals to sound and/or pressure waves.

In some examples, audio output device 102 can include headphones. As used herein, the term “headphones” can, for example, refer to devices designed to be worn on or around the head of a user, where the devices can convert electrical signals to an audio output such as sound and/or pressure waves to emit the audio output to a space next to the devices, such as into the user's ears. For example, a user 106 can wear headphones while listening to an audio output from the headphones, such as a telephone call, music, etc. As used herein, a user may refer to a person interacting with and/or using audio output device 102.

In some examples, audio output device 102 can include a headset. As used herein, the term “headset” can, for example, refer to devices that include a microphone and are designed to be worn on or around the head of a user. The devices can convert electrical signals to an audio output such as sound and/or pressure waves to emit the audio output to a space next to the devices, and the microphone can convert sound and/or pressure waves into an electrical signal. That is, a headset can be headphones with a microphone. For example, a user 106 can wear a headset while listening to a telephone call, and speak such that the microphone converts the user's 106 speech into an electrical signal such that other persons, such as those on the telephone call, can hear the headset user's 106 speech.

In some examples, audio output device 102 can include a speaker. As used herein, the term “speaker” can, for example, refer to a device such as an electroacoustic transducer which can convert an electrical signal to an audio output such as sound and/or pressure waves. The audio output can be output to a space next to the speaker. For example, a user 106 can listen to an audio output from the speaker, such as a telephone call, music, etc.

Audio output device 102 can receive an input from camera 104 in response to camera 104 detecting the presence of person 108. As used herein, a person may refer to a person other than a user 106 of the audio output device 102. As used herein, the term “camera” can, for example, refer to a device that can record and/or capture images. Camera 104 can be an infrared (IR) camera, a red, green, and blue (RGB) camera, and/or a time-of-flight (ToF) camera, among other types of cameras. For example, camera 104 can be an IR camera, where the IR camera detects the presence of person 108. In response to camera 104 detecting the presence of person 108 (e.g., via the IR camera), camera 104 can send a signal to audio output device 102.

Audio output device 102 and camera 104 can be interconnected such that audio output device 102 can receive the input from camera 104 in response to camera 104 detecting the presence of person 108. As used herein, the term “interconnect” or used descriptively as “interconnected” can, for example, refer to a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

In some examples, audio output device 102 and camera 104 can be wirelessly interconnected via a network relationship. As used herein, the term “network relationship” can, for example, refer to a local area network (LAN), a virtual local area network (VLAN), wide area network (WAN), personal area network (PAN), a distributed computing environment (e.g., a cloud computing environment), storage area network (SAN), Metropolitan area network (MAN), a cellular communications network, and/or the Internet, among other types of network relationships.

In some examples, camera 104 can detect the presence of person 108 via video detection. For example, camera 104 can be an IR camera, an RGB camera, a ToF camera, etc. Camera 104 can visually detect the presence of person 108 by, for example, recording or capturing images of person 108.

In some examples, camera 104 can visually detect the presence of person 108 by utilizing gaze detection. As used herein, gaze detection may refer to the process of measuring a point of gaze or a motion of an eye of a person relative to the person's head. Camera 104 can utilize gaze detection to determine whether person 108 is looking at or in a general direction of user 106. Camera 104 can use gaze detection to detect the presence of person 108 in response to the person 108 looking at or in the general direction of user 106.

Camera 104 can detect the presence of person 108 being within a threshold distance 110 of camera 104. For example, an IR camera can detect the presence of person 108 being within threshold distance 110. Based on the detection of person 108 being within threshold distance 110, camera 104 can send, and audio output device 102 can receive a signal from camera 104 indicating camera 104 has detected the presence of person 108.

Threshold distance 110 can be predetermined and/or configurable. For example, threshold distance 110 can be increased or decreased. For instance, user 106 may work in a cubicle, and camera 104 may be detecting the presence of persons walking past the cubicle of user 106. Threshold distance 110 may be decreased so that camera 104 detects persons intending to stop at user's 106 cubicle, but not persons merely walking by user's 106 cubicle. Threshold distance 110 may be increased if camera 104 fails to detect the presence of persons intending to stop at user's 106 cubicle.

Camera 104 can detect the presence of person 108 being within threshold distance 110 of camera 104 for a threshold period of time. For example, an IR camera can detect the presence of person 108 being within threshold distance 110 for five seconds. Based on the detection of person 108 being within threshold distance 110, camera 104 can send and audio output device 102 can receive a signal from camera 104 indicating camera 104 has detected the presence of person 108.

The threshold period of time can be predetermined and/or configurable. For example, the threshold period of time can be increased or decreased. For instance, the threshold period of time can be longer than five seconds or shorter than five seconds.

Audio output device 102 can modify an audio setting of audio output device 102 in response to receiving the input from camera 104. For example, camera 104 can audibly and/or visually detect the presence of person 108 and send an input to audio output device 102 in response to detecting the presence of person 108. In response to receiving the input from camera 104, audio output device 102 can modify an audio setting of audio output device 102 based on the detection of the presence of person 108.

Modifying an audio setting of audio output device 102 can include modifying noise cancellation settings of audio output device 102. As used herein, the term “noise cancellation” can, for example, refer to a technique for reducing an unwanted first sound by an addition of a second sound designed to cancel the first sound. For example, user 106 may be using audio output device 102, where audio output device 102 is employing noise cancellation to reduce and/or eliminate ambient sounds around user 106 so that user 106 can focus on the audio output of audio output device 102. Audio output device 102 can modify noise cancellation settings of audio output device 102 so that user 106 can be made aware of the presence of person 108.

Modification of noise cancellation settings can include reducing noise cancellation of the audio output of audio output device 102. For example, audio output device 102 can reduce noise cancellation such that audio output device 102 still utilizes noise cancellation, but at a level of noise cancellation that is lower relative to the level of noise cancellation prior to the reduction, while still outputting the audio output of the audio output device 102. The lower level of noise cancellation used by audio output device 102 can allow user 106 to be made aware of the presence of person 108 without deactivating noise cancellation.

Modification of noise cancellation settings can deactivate noise cancellation of the audio output of audio output device 102. As used herein, the term “deactivate” or used descriptively as “deactivated” can, for example, refer to a state of being inactive or inoperative. For example, audio output device 102 can deactivate noise cancellation such that audio output device 102 does not utilize noise cancellation while still outputting the audio output of the audio output device 102. The absence of noise cancellation by audio output device 102 can allow user 106 to be made aware of the presence of person 108.

Modifying an audio setting of audio output device 102 can include modifying volume settings of audio output device 102. As used herein, the term “volume” can, for example, refer to a degree of sound intensity or audibility. For example, user 106 may be using audio output device 102 at a volume such that user 106 can focus on the audio output of audio output device 102 and not on ambient sounds around user 106. Audio output device 102 can modify the volume settings of audio output device 102 so that user 106 can be made aware of the presence of person 108. Modification of the audio setting of audio output device 102 can include lowering the volume settings of audio output device 102.

In some examples, audio output device 102 can receive an audio input from a microphone of audio output device 102 and output the audio input received from the microphone via the audio output of audio output device 102. For example, person 108 may try talking to user 106 to get user's 106 attention. A microphone of audio output device 102 may pick up the speech of person 108 and output the speech of person 108 via the audio output of audio output device 102. In this manner, use 106 may be alerted to the presence of person 108 via the speech of person 108 through the audio output of audio output device 102.

Camera 104 can detect the presence of person 108 via facial recognition. As used herein, the term “facial recognition” can, for example, refer to identifying a unique person from a digital image or video frame from a video source. For example, camera 104 can detect the presence of person 108 and determine an identity of person 108. The identity of person 108 can be determined by, for instance, comparing facial features of person 108 from an image including facial features of person 108 taken by camera 104 with a database (not shown in FIG. 1) of facial images. Based on the comparison of the image from camera 104 and the database of facial images, an identity of person 108 can be determined. That is, if the facial images of the image from camera 104 match the facial images included in images of the database of facial images, an identity of person 108 can be determined.

The database can be local or remote from system 100. Camera 104 can be interconnected with the database via a network relationship.

Audio output device 102 can modify an audio setting based on an identity of person 108 recognized via the facial recognition. For example, based on the identity of person 108, audio setting rules may be employed by audio output device 102. For instance, audio output device 102 may turn off noise cancellation settings based on the identity of person 108 being a boss or supervisor of user 106, while audio output device 102 may merely reduce noise cancellation levels based on the identity of person 108 being a colleague or co-worker of user 106.

Audio output device 102 can reduce a volume of the audio output device 102 based on an identity of person 108 recognized via the facial recognition. For example, audio output device 102 can be a speaker, and audio output device 102 can reduce a volume of audio output device 102 in response to receiving an input from the IR camera. The input from the IR camera can include an identity of person 108. In some examples, the volume may be reduced to a first level based on an identity of person 108, and the volume may be reduced to a second level based on a different identity of a different person from person 108, where the first volume level may be higher or lower than the second volume level. That is, the volume of audio output device 102 can be reduced to different volume levels based on the identity of the detected person 108.

Audio setting rules may be configurable. For example, user 106 may define audio setting rules based on the identity of person 108. For instance, user 106 may define audio setting rules such that an audio setting of audio output device 102 is modified based on the identity of a first person determined via facial recognition by camera 104, and an audio setting of audio output device 102 is not modified based on the identity of a second person determined via facial recognition by camera 104. That is, user 106 can define audio setting rules based on user preferences.

In some examples, audio output device 102 can reduce noise cancellation of the audio output of audio output device 102 in response to detecting the presence of a first person. That is, based on the identity of the first person, audio output device 102 can reduce noise cancellation of the audio output of audio output device 102.

In some examples, audio output device 102 can deactivate noise cancellation of the audio output of audio output device 102 in response to detecting the presence of a second person. That is, based on the identity of the second person, audio output device 102 can deactivate noise cancellation of the audio output of audio output device 102.

In some examples, audio output device 102 can modify an audio setting based on an amount of persons within threshold distance 110 of camera 104. For example, audio output device 102 can reduce noise cancellation of the audio output of audio output device 102 in response to detecting the presence of one person within threshold distance 110 of camera 104, and audio output device 102 can deactivate noise cancellation of the audio output of audio output device 102 in response to detecting the presence of two persons or more than two persons within threshold distance 110 of camera 104.

The amount of persons for different modifications of the audio setting can be configurable. For instance, audio output device 102 can reduce noise cancellation of the audio output of audio output device 102 in response to detecting the presence of at least one person within threshold distance 110 of camera 104. Audio output device 102 can deactivate noise cancellation of the audio output of audio output device 102 in response to detecting the presence of at least two persons within threshold distance 110 of camera 104.

Examples of the disclosure are not limited to the above amount of persons for different modifications of the audio setting. For instance, audio output device 102 can reduce noise cancellation of the audio output of audio output device 102 in response to detecting the presence of any amount of persons within threshold distance 110 of camera 104, and audio output device 102 can deactivate noise cancellation of the audio output of audio output device 102 in response to detecting the presence of any amount of persons within threshold distance 110 of camera 104.

Audio output device 102 can increase an audio setting of audio output device 102 in response to detecting, by camera 104, an absence of person 108 being within threshold distance 110 of camera 104 for a threshold period of time. For example, person 108 may have entered the threshold distance 110 and caused audio output device 102 to reduce or deactivate noise cancellation of the audio output of audio output device 102. In response to person 108 leaving threshold area 110 for a threshold period of time, such as for one minute, audio output device 102 can increase or reactivate the noise cancellation of the audio output of audio output device 102. For instance, person 108 may have entered threshold distance 110 to speak with user 106, causing noise cancellation of the audio output of audio output device 102 to be decreased, and after speaking with user 106, leaves threshold distance 110 for the threshold period of time, allowing noise cancellation of the audio output of audio output device 102 to be increased.

Audio setting modification based on presence detection can allow a user of an audio output device to more easily determine when a person may be attempting to get the user's attention. This can allow the person to more easily gain the user's attention without having to speak loudly or physically touch the user. Audio setting modification based on presence detection can allow the user to focus on the audio output of the audio output device without worrying about whether another person is trying to get their attention.

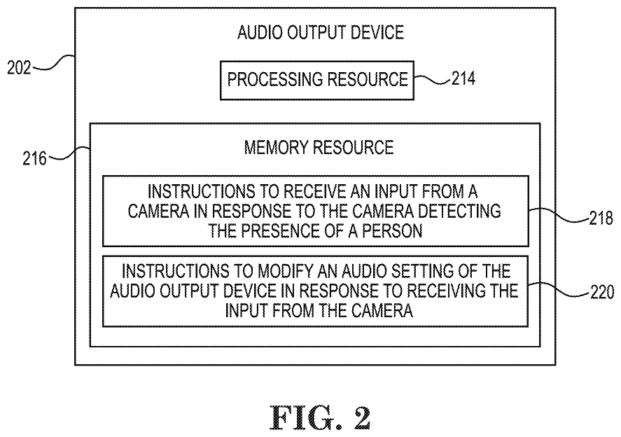

FIG. 2 illustrates a block diagram of an example of an audio output device 202 consistent with the disclosure. Audio output device 202 (e.g., audio output device 102, previously described in connection with FIG. 1) can include a processing resource 214 and a memory resource 216. Memory resource 216 can include machine readable instructions, including receive an input instructions 218 and modify an audio setting instructions 220.

Processing resource 214 may be a central processing unit (CPU), a semiconductor based microprocessor, and/or other hardware devices suitable for retrieval and execution of machine-readable instructions 218, 220 stored in a memory resource 216. Processing resource 214 may fetch, decode, and execute instructions 218, 220. As an alternative or in addition to retrieving and executing instructions 218, 220, processing resource 214 may include a plurality of electronic circuits that include electronic components for performing the functionality of instructions 218, 220.

Memory resource 216 may be any electronic, magnetic, optical, or other physical storage device that stores executable instructions 218, 220 and/or data. Thus, memory resource 216 may be, for example, Random Access Memory (RAM), an Electrically-Erasable Programmable Read-Only Memory (EEPROM), a storage drive, an optical disc, and the like. Memory resource 216 may be disposed within audio output device 202, as shown in FIG. 2. Additionally and/or alternatively, memory resource 216 may be a portable, external or remote storage medium, for example, that allows audio output device 202 to download the instructions 218, 220 from the portable/external/remote storage medium.

Processing resource 214 may execute receive an input instructions 218 stored in memory resource 216 to receive an input from a camera (e.g., camera 104, previously described in connection with FIG. 1) in response to the camera detecting the presence of a person. The camera can detect the presence of a person via video detection. The camera can be, for example, an IR camera, an RGB camera, and/or a ToF camera, among other types of cameras.

Processing resource 214 may execute modify an audio setting instructions 220 to modify an audio setting of the audio output device 202 based on an identity of the person in response to receiving the input from the camera. For example, processing resource 214 can execute instructions 220 to modify a noise cancellation setting and/or a volume setting of audio output device 202. In some examples, modification of a noise cancellation setting can include reducing a noise cancellation level of the audio output of audio output device 202 or deactivating noise cancellation of the audio output of audio output device 202. In some examples, modification of a volume setting of audio output device 202 can include reducing the volume of the audio output of audio output device 202.

Modification of an audio setting of audio output device 202 can be based on an identity of the presence of a person detected by the camera. For example, audio output device 202 can deactivate noise cancellation of the audio output of audio output device 202 in response to the presence of one person, but can reduce the volume of the audio output of audio output device 202 in response to the presence of a different person.

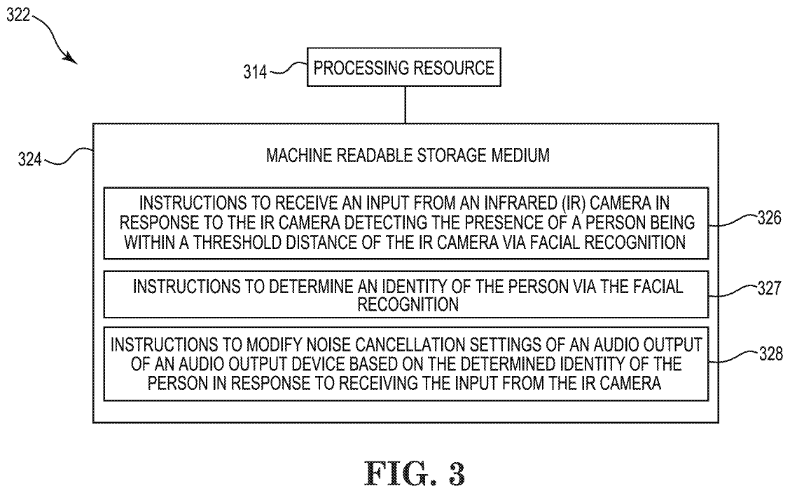

FIG. 3 illustrates a block diagram of an example of a system 322 suitable for audio setting modification based on presence detection consistent with the disclosure. In the example of FIG. 3, system 322 includes a processing resource 314 (e.g., processing resource 214, previously described in connection with FIG. 2) and a machine readable storage medium 324. Although the following descriptions refer to an individual processing resource and an individual machine readable storage medium, the descriptions may also apply to a system with multiple processing resources and multiple machine readable storage mediums. In such examples, the instructions may be distributed across multiple machine readable storage mediums and the instructions may be distributed across multiple processing resources. Put another way, the instructions may be stored across multiple machine readable storage mediums and executed across multiple processing resources, such as in a distributed computing environment.

Processing resource 314 may be a central processing unit (CPU), microprocessor, and/or other hardware device suitable for retrieval and execution of instructions stored in machine readable storage medium 324. In the particular example shown in FIG. 3, processing resource 314 may receive, determine, and send instructions 326, 327, and 328. As an alternative or in addition to retrieving and executing instructions, processing resource 314 may include an electronic circuit comprising an electronic component for performing the operations of the instructions in machine readable storage medium 324. With respect to the executable instruction representations or boxes described and shown herein, it should be understood that part or all of the executable instructions and/or electronic circuits included within one box may be included in a different box shown in the figures or in a different box not shown.

Machine readable storage medium 324 may be any electronic, magnetic, optical, or other physical storage device that stores executable instructions. Thus, machine readable storage medium 324 may be, for example, Random Access Memory (RAM), an Electrically-Erasable Programmable Read-Only Memory (EEPROM), a storage drive, an optical disc, and the like. The executable instructions may be “installed” on the system 322 illustrated in FIG. 3. Machine readable storage medium 324 may be a portable, external or remote storage medium, for example, that allows the system 324 to download the instructions from the portable/external/remote storage medium. In this situation, the executable instructions may be part of an “installation package”. As described herein, machine readable storage medium 324 may be encoded with executable instructions related to audio setting modification based on presence detection. That is, using processing resource 314, machine readable storage medium 324 may instruct an audio output device to modify noise cancellation settings in response to receiving an input from an IR camera, among other operations.

Instructions 326 to receive an input from an IR camera in response to the IR camera detecting the presence of a person being within a threshold distance (e.g., threshold distance 110, previously described in connection with FIG. 1) of the IR camera via facial recognition, when executed by processing resource 314, may cause system 322 to receive an input based on the IR camera detecting the presence of a person within a threshold distance of the IR camera via facial recognition. As used herein, the term “IR camera” can, for example, refer to a device that can form an image using infrared radiation. For example, the IR camera can detect the presence of a person within a threshold distance of the IR camera, and send, in response to detecting the presence of the person, an input to the audio output device.

Instructions 327 to determine an identity of the person via the facial recognition, when executed by processing resource 314, may cause system 322 to determine an identity of the person via facial recognition. For example, facial features of the person can be compared with a database of facial images to determine the identity of the person.

Instructions 328 to modify noise cancellation settings of an audio output of an audio output device based on the determined identity of the person in response to receiving the input from the IR camera, when executed by processing resource 314, may cause system 322 to modify noise cancellation settings of the audio output of the audio output device. System 322 can modify the noise cancellation settings of the audio output of the audio output device based on an identity of the person detected by the IR camera. For example, system 322 can reduce or deactivate noise cancellation of the audio output of the audio output device in response to the identity of the person detected by the IR camera.

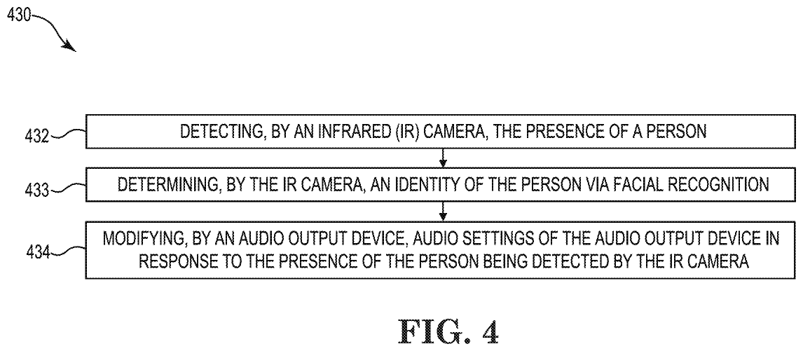

FIG. 4 illustrates an example of a method 430 for audio setting modification based on presence detection consistent with the disclosure. For example, method 430 can be performed by an audio output device (e.g., audio output device 102, 202, previously described in connection with FIGS. 1 and 2, respectively) to provide audio setting modification based on presence detection.

At 432, the method 430 includes detecting, by an IR camera, the presence of a person. The IR camera can detect the presence of a person being within a threshold distance (e.g., threshold distance 110, previously described in connection with FIG. 1) of the IR camera. For example, if a person is within five feet of the IR camera, the IR camera may detect the presence of the person, but if the person is farther than five feet from the IR camera, the IR camera may not detect the person, although examples of the disclosure are not limited to a five foot threshold distance. For example, the threshold distance can be greater than five feet or less than five feet. In some examples, the threshold distance can be configurable.

In some examples, the IR camera can detect the presence of a person being within a threshold distance of the IR camera for a threshold period of time. For example, the threshold distance of the IR camera can be five feet. The IR camera can detect the presence of a person being within five feet of the IR camera for ten seconds or longer, but if the person is within five feet of the IR camera for less than ten seconds, the IR camera may not detect the person, although examples of the disclosure are not limited to a threshold period of time of ten seconds. For example, the threshold period of time can be greater than ten seconds or less than ten seconds. In some examples, the threshold period of time can be configurable.

At 433, the method 430 includes determining, by the IR camera, an identity of the person via facial recognition. For example, the IR camera can determine the identity of the person via facial recognition by comparing facial features of the detected person with a database of facial images to determine an identity of the detected person.

At 434, the method 430 includes modifying, by an audio output device, audio settings of the audio output device in response to the presence of the person being detected by the IR camera. In some examples, modifying audio settings of the audio output device can include reducing or deactivating noise cancellation settings of the audio output device. In some examples, modifying audio settings of the audio output device can include reducing volume settings of the audio output device.

Method 430 can include modifying the audio settings of the audio output device based on audio setting rules corresponding to an identity of the person detected via facial recognition by the IR camera. For instance, audio settings of the audio output device can be modified in one manner in response to an identity of a first detected person, and audio settings of the audio output device can be modified in a different manner than the first person in response to an identity of a second detected person who is different from the first person.

Method 430 can include increasing, by the audio output device, the audio settings of the audio output device in response to detecting, by the IR camera, an absence of the person being within a threshold distance of the IR camera for a threshold period of time. For example, once the IR camera detects the person no longer being within five feet of the IR camera, and the person is not within five feet of the IR camera for ten seconds, the audio output device can increase the audio settings of the audio output device. The audio output device can activate or increase noise cancellation settings of the audio output device, and/or increase volume settings of the audio output device. In some examples, the threshold period of time can be configurable.

As used herein, “logic” is an alternative or additional processing resource to perform a particular action and/or element described herein. Logic can include hardware. The hardware can include processing resources such as circuitry, which are distinct from machine-readable instructions on a machine readable media. Further, as used herein, “a” can refer to one such thing or more than one such thing.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An audio output device, comprising:
a processing resource; and
a memory resource storing machine readable instructions to cause the processing resource to:
receive an input from a camera in response to the camera detecting a presence of a person; and
modify an audio setting of the audio output device based on an identity of the person in response to receiving the input from the camera.

2. The audio output device of claim 1, wherein the instructions to modify the audio setting include instructions to cause the processing resource to modify noise cancellation settings of the audio output device.

3. The audio output device of claim 1, wherein the instructions to modify the audio setting include instructions to cause the processing resource to modify volume settings of the audio output device.

4. The audio output device of claim 1, wherein the camera detects the presence of the person via facial recognition.

5. The audio output device of claim 4, comprising instructions to cause the processing resource to determine the identity of the person via the facial recognition.

6. The audio output device of claim 1, wherein the audio output device is a device from a list comprising:
headphones;
a headset; or
a speaker.

7. A non-transitory machine readable storage medium having stored thereon machine readable instructions to cause a processing resource to:
receive an input from an infrared (IR) camera in response to the IR camera detecting the presence of a person being within a threshold distance of the IR camera via facial recognition;
determine an identity of the person via the facial recognition; and
modify noise cancellation settings of an audio output of an audio output device based on the determined identity of the person in response to receiving the input from the IR camera.

8. The medium of claim 7, wherein the instructions to modify noise cancellation settings include instructions to cause the processing resource to:
reduce noise cancellation of the audio output of the audio output device in response to a determined identity of a first person; and
deactivate noise cancellation of the audio output of the audio output device in response to a determined identity of a second person.

9. The medium of claim 7, comprising instructions to cause the processing resource to:
receive an audio input from a microphone of the audio output device; and
output the audio input received from the microphone via the audio output of the audio output device.

10. The medium of claim 7, comprising instructions to cause the processing resource to reduce a volume of a speaker in response to receiving the input from the IR camera.

11. A method, comprising:
detecting, by an infrared (IR) camera, the presence of a person;
determining, by the IR camera, an identity of the person via facial recognition; and
modifying, by an audio output device, audio settings of the audio output device in response to the determined identity of the person being detected by the IR camera.

12. The method of claim 11, wherein detecting the presence of the person by the IR camera includes detecting, by the IR camera, the presence of the person being within a threshold distance of the IR camera.

13. The method of claim 11, wherein detecting the presence of the person by the IR camera includes detecting, by the IR camera, the presence of the person being within the threshold distance of the IR camera for a threshold period of time.

14. The method of claim 11, wherein the method includes modifying the audio settings of the audio output device based on audio setting rules corresponding to an identity of the person detected via the facial recognition by the IR camera.

15. The method of claim 11, wherein the method includes increasing, by the audio output device, the audio settings of the audio output device in response to detecting, by the IR camera, an absence of the person being within a threshold distance of the IR camera for a threshold period of time.
